(19) United States
(12) Patent Application Publication
(10) Pub. No.: US 2026/0277128 A1
(43) Pub. Date: Sep. 17, 2026

(54) IMAGE FORMING APPARATUS AND IMAGE FORMING METHOD

(71) Applicant: FUJIFILM Business Innovation Corp., Tokyo (JP)

(72) Inventors: Yukiaki NAKAMURA, Kanagawa (JP); Kohei MANABE, Kanagawa (JP)

(73) Assignee: FUJIFILM Business Innovation Corp., Tokyo (JP)

(21) Appl. No.: 19/283,251

(22) Filed: Jul. 29, 2025

(30) Foreign Application Priority Data
Mar. 13, 2025 (JP) 2025-040730

(51) Int. Cl. G03G 15/01; G03G 9/09

(52) U.S. Cl. CPC G03G 15/0189; G03G 9/091; G03G 9/0914; G03G 15/0126; G03G 15/0131; G03G 2215/0604

(57) ABSTRACT

An image forming apparatus includes a first image forming unit that forms a first toner image by using a toner having a first fluorescent color, a second image forming unit that forms a second toner image by using a toner having a second fluorescent color, and a transfer unit that transfers the first toner image to a recording medium by superimposing the first toner image on the second toner image such that the first toner image is located above the second toner image on the recording medium, in which a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

### CROSS-REFERENCE TO RELATED APPLICATIONS

This application is based on and claims priority under 35 USC 119 from Japanese Patent Application No. 2025-040730 filed Mar. 13, 2025.

### BACKGROUND

### (i) Technical Field

The present disclosure relates to an image forming apparatus and an image forming method.

### (ii) Related Art

JP2019-132993A discloses a toner that includes a plurality of toner particles including toner base particles containing a fluorescent pigment and a binder and external additives fixed to a surface of the toner base particles, a content of the fluorescent pigment in the toner base particles is 0.3% by weight or more and 3.0% by weight or less, and a ratio of a number-based particle size distribution of the plurality of toner particles to a volume-based particle size distribution of the plurality of toner particles is 0.66 or more and 1.00 or less.

JP2000-181170A discloses a color image forming method in which color correction is performed by sharing an additive color mixing in a subtractive color mixing.

JP2006-251694A discloses an image forming apparatus including a first image forming unit that forms a toner image having a fluorescent color, a second image forming unit that forms a toner image having a color other than the fluorescent color, and a transfer unit that transfers the toner image having the fluorescent color to a recording medium by superimposing the toner image having the fluorescent color on the toner image having the color other than the fluorescent color such that the toner image having the fluorescent color is located above the toner image having the color other than the fluorescent color on the recording medium.

### SUMMARY

Aspects of non-limiting embodiments of the present disclosure relate to an image forming apparatus that includes a first image forming unit that forms a first toner image by using a toner having a first fluorescent color, a second image forming unit that forms a second toner image by using a toner having a second fluorescent color, and a transfer unit that transfers the first toner image to a recording medium by superimposing the first toner image on the second toner image such that the first toner image is located above the second toner image on the recording medium, in which chroma of a secondary color in an obtained image is excellent as compared with a case where a photoluminescent intensity in a case where the toner image formed by using only the toner having the second fluorescent color is irradiated with ultraviolet rays having a wavelength of 365 nm is equal to or lower than a photoluminescent intensity in a case where the toner image formed by using only the toner having the first fluorescent color is irradiated with ultraviolet rays having a wavelength of 365 nm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object include the following aspects.

According to an aspect of the present disclosure, there is provided an image forming apparatus including a first image forming unit that forms a first toner image by using a toner having a first fluorescent color, a second image forming unit that forms a second toner image by using a toner having a second fluorescent color, and a transfer unit that transfers the first toner image to a recording medium by superimposing the first toner image on the second toner image such that the first toner image is located above the second toner image on the recording medium, in which a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

### BRIEF DESCRIPTION OF THE DRAWINGS

Exemplary embodiment(s) of the present invention will be described in detail based on the following figures, wherein:

FIG. 1 is a view schematically showing the configuration of an example of an image forming apparatus according to the present exemplary embodiment; and

FIG. 2 is a view schematically showing the configuration of an example of a process cartridge detachable from the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit value or lower limit value of a numerical range may be replaced with the upper limit value or lower limit value of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are a plurality of substances corresponding to each component in the composition, unless otherwise specified, the amount of each component means the total amount of the plurality of the substances present in the composition.

In the present disclosure, each component may include a plurality of corresponding particles. In a case where a plurality of kinds of particles corresponding to each component are present in a composition, the particle diameter of each component indicates the value of a mixture of the plurality of kinds of particles present in the composition, unless otherwise specified.

In the present disclosure, “(meth)acrylic” is an expression including both acrylic and methacrylic, and “(meth)acrylate” is an expression including both acrylate and methacrylate.

In the present disclosure, “electrostatic charge image developing toner” is also called “toner”, “fluorescent green toner” is also called “green toner”, “electrostatic charge image developer” is also called “developer”, and “electrostatic charge image developing carrier” is also called “carrier”.

### Image Forming Apparatus

An image forming apparatus according to the present exemplary embodiment includes a first image forming unit that forms a first toner image by using a toner having a first fluorescent color, a second image forming unit that forms a second toner image by using a toner having a second fluorescent color, and a transfer unit that transfers the first toner image to a recording medium by superimposing the first toner image on the second toner image such that the first toner image is located above the second toner image on the recording medium, in which a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

In the toner of the related art having a fluorescent color, the color developing property is greatly improved by adding the emission in the visible light region in a case where the toner absorbs a wavelength in the ultraviolet region to the spectral reflectance of the colorant. However, in a case where the toner images having the fluorescent colors are superimposed on each other, the ultraviolet rays are absorbed by the toner image of the upper layer, the light emission of the toner image of the lower layer is hindered, the color developing property (color gamut) is deteriorated, and the chroma of the secondary color is deteriorated.

The image forming apparatus according to the present exemplary embodiment includes a transfer unit that transfers the first toner image to a recording medium by superimposing the first toner image on the second toner image such that the first toner image is located above the second toner image on the recording medium, in which it is presumed that chroma of the secondary color is excellent since a photoluminescent intensity in a case where the toner image formed by using only the toner having the second fluorescent color is irradiated with ultraviolet rays having a wavelength of 365 nm is set to be higher than a photoluminescent intensity in a case where the toner image formed by using only the toner having the first fluorescent color is irradiated with ultraviolet rays having a wavelength of 365 nm, a toner having excellent color development even in a state where an amount of ultraviolet rays is small, so that a color region can be narrowed even in a case where the toner having the fluorescent color in the upper layer.

In the present exemplary embodiment, the fluorescent colorant is a colorant that emits light by energy from the outside, and the non-fluorescent colorant is a colorant that does not emit light by energy from the outside. Generally, the fluorescent colorant shows color by reflected light and light emission, and the non-fluorescent colorant shows color only by reflected light. The energy from the outside is, for example, light energy.

From the viewpoint of the chroma of the secondary color, the ratio (the toner having the second fluorescent color/the toner having the first fluorescent color) of the photoluminescent intensity in a case where the toner image formed by using only the toner having the second fluorescent color is irradiated with ultraviolet rays having a wavelength of 365 nm to the photoluminescent intensity in a case where the toner image formed by using only the toner having the first fluorescent color is irradiated with ultraviolet rays having a wavelength of 365 nm, for example, preferably 1.2 or more, more preferably 1.5 or more, still more preferably 1.5 or more and 12.0 or less, and particularly preferably 1.5 or more and 8.0 or less.

From the viewpoint of the chroma of the secondary color, the photoluminescent intensity in a case where the toner image formed by using only the toner having the first fluorescent color is irradiated with ultraviolet rays having a wavelength of 365 nm is, for example, preferably 100 or more and 8,000 or less, more preferably 200 or more and 5,000 or less, still more preferably 500 or more and 5,000 or less, and particularly preferably 3,000 or more and 5,000 or less.

From the viewpoint of the chroma of the secondary color, the photoluminescent intensity in a case of irradiating the toner image formed by using only the toner having the second fluorescent color with ultraviolet rays having a wavelength of 365 nm is, for example, preferably 1,000 or more and 20,000 or less, more preferably 3,000 or more and 10,000 or less, still more preferably 5,000 or more and 10,000 or less, and particularly preferably 6,000 or more and 9,000 or less.

From the viewpoint of color developing property and visibility in proofing conditions for color evaluation in the printing and graphic arts industry (D50 daylight with a color temperature of 5003K), a total value of the photoluminescent intensity in a case where the toner image formed by using only the toner having the first fluorescent color is irradiated with ultraviolet rays having a wavelength of 365 nm and the photoluminescent intensity in a case where the toner image formed by using only the toner having the second fluorescent color is irradiated with ultraviolet rays having a wavelength of 365 nm is, for example, preferably 2,000 to 20,000, more preferably 4,000 to 15,000, and even more preferably 6,000 to 12,000.

The method of measuring the photoluminescent intensity in a case where the toner image according to the present exemplary embodiment is irradiated with ultraviolet rays having a wavelength of 365 nm is as follows.

The fluorescence spectrum of the toner image is measured with a spectrophotofluorometer (F4500 manufactured by Hitachi High-Tech Corporation).

A spectrally separated xenon lamp light source is used as the excitation light, an excitation wavelength is set to 365 nm, a fluorescence start wavelength is set to 380 nm, a fluorescence end wavelength is set to 600 nm, a scan speed is set to 240 nm/min, an excitation side slit is set to 2.5 nm, a fluorescence side slit is set to 1 nm, and a photomultiplier voltage is set to 950 V.

The height and the peak area of the peak wavelength of the fluorescence spectrum measured under the present conditions are read, and the peak area is defined as the image light emission peak area.

Further, similarly, the image light emission peak area in a case where the excitation light is not emitted is measured.

The value of the image light emission peak area in a case where the excitation light is emitted/the image light emission peak area in a case where the excitation light is not emitted is used as the photoluminescent intensity.

In addition, the unit of the photoluminescent intensity in the present exemplary embodiment is dimensionless.

In addition, the colors of the toner having the first fluorescent color and the toner having the second fluorescent color are not particularly limited. Examples thereof include a fluorescent green toner, a fluorescent pink toner, a fluorescent red toner, a fluorescent orange toner, a fluorescent yellow toner, a fluorescent blue toner, and a fluorescent purple toner.

From the viewpoint of further exerting the effects of the present exemplary embodiment, it is preferable that the color of the toner having the first fluorescent color and the color of the toner having the second fluorescent color are, for example, different colors.

Among these, the toner having a second fluorescent color is, for example, more preferably a fluorescent green toner, a fluorescent yellow toner, or a fluorescent orange toner, and particularly preferably a fluorescent green toner.

The toner having a first fluorescent color is, for example, preferably a fluorescent green toner or a fluorescent pink toner, and more preferably a fluorescent pink toner.

Further, the toner having the first fluorescent color and the toner having the second fluorescent color are, for example, preferably toners having a core/shell structure.

### Fluorescent Colorant

The toner having the first fluorescent color and the toner having the second fluorescent color contain a fluorescent colorant.

The fluorescent colorant is not limited in color or the like as long as the fluorescent organic pigment is a fluorescing organic pigment. Examples thereof include a fluorescent yellow organic pigment, a fluorescent pink organic pigment, a fluorescent red organic pigment, a fluorescent orange organic pigment, a fluorescent green organic pigment, and a fluorescent purple organic pigment.

Examples of the fluorescent colorant include an azomethine compound, an isoindolinone compound, a xanthene compound (including a rhodamine compound, a fluorescein compound, and an eosin compound), a thioxanthene compound, a coumarin compound, a perylene compound, a naphthalimide compound, a naphthalene compound, and a triarylmethane compound.

Among these, the toner having the second fluorescent color preferably contains, for example, an azomethine compound, and more preferably contains a bisazomethine compound from the viewpoint of the chroma of the secondary color.

Examples of the azomethine compound include a compound having an azomethine structure represented by —R¹C═N— (R¹ is a hydrogen atom or a monovalent substituent).

Examples of the bisazomethine compound include a compound having a bisazomethine structure represented by —R¹C═N—N═CR²— (R¹ and R² each independently represent a hydrogen atom or a monovalent substituent) in the molecular structure.

The fluorescent colorant preferably has, for example, a hydrophilic group.

Examples of the hydrophilic group in the fluorescent colorant include a hydroxy group, primary to tertiary amino groups, a carboxy group, a sulfo group, a phosphoric acid group, and the like.

Among these, the fluorescent colorant preferably has, for example, a hydroxy group as the hydrophilic group.

As the fluorescent colorant, for example, an azomethine compound is preferable, and the following azomethine compounds (1) to (3) are more preferable.

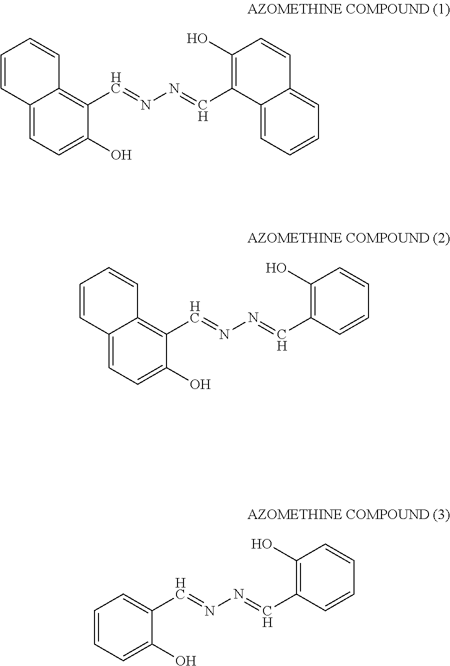 [SMILES: Oc1ccc2ccccc2c1/C=N/N=C/c1c(O)ccc2ccccc12 ; Oc1ccccc1/C=N/N=C/c1c(O)ccc2ccccc12 ; Oc1ccccc1/C=N/N=C/c1ccccc1O]

The emission peak wavelength of the azomethine compound (1) is 520 nm.

The emission peak wavelength of the azomethine compound (2) is 510 nm.

The emission peak wavelength of the azomethine compound (3) is 520 nm.

As the fluorescent colorant, for example, an azomethine compound derivative is preferable, and a boron difluoride derivative of an azomethine compound is more preferable.

Examples of the boron difluoride derivative of an azomethine compound include the following compounds.

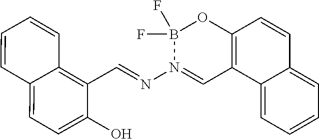

The fluorescent colorant is, for example, preferably at least one kind of compound selected from the group consisting of the azomethine compound (1), the azomethine compound (2), the azomethine compound (3), and boron difluoride derivatives of these.

From the viewpoint of the chroma of the secondary color, the toner having the second fluorescent color contains, for example, preferably C.I. Pigment Yellow 101 or a boron difluoride derivative of C.I. Pigment Yellow 101, and more preferably C.I. Pigment Yellow 101. C.I. Pigment Yellow 101 is the azomethine compound (1).

Examples of the fluorescent colorant include a rhodamine compound (for example, Basic red 1 and Basic Violet 11:1) as a fluorescent pink colorant.

Examples of the fluorescent yellow colorant include a thioxanthene compound (for example, Solvent yellow 98), a coumarin compound (for example, Solvent yellow 160:1, Basic Yellow 40, Disperse Yellow 82, 184, 186, or 232), a perylene compound (for example, Solvent Green 5), and a naphthalimide compound (for example, Solvent Yellow 43, 44, or 116).

From the viewpoint of achieving the bending resistance and peelability of the obtained image, dispersibility in the toner particles, color showing properties on a recording medium, fixing properties on a recording medium, and the like in a well-balanced manner, a volume-average particle size D50v of the fluorescent colorant is, for example, preferably 30 nm or more and 800 nm or less, more preferably 100 nm or more and 500 nm or less, and even more preferably 200 nm or more and 400 nm or less.

The volume-average particle size of the colorant, particularly the pigment, is measured by dispersing the colorant in an aqueous solution of a surfactant and using a laser diffraction type particle size distribution measuring device (for example, LA-700 manufactured by Horiba, Ltd.). The volume-based particle size distribution is plotted from the small particle size, and the particle size at which the cumulative percentage of the particles reaches 50% is adopted as the volume-average particle size.

The toner particles may contain one kind of fluorescent colorant alone or two or more kinds of fluorescent colorants. From the viewpoint of brightness and chroma of the obtained image, for example, it is preferable that the toner particles contain one kind of fluorescent colorant alone.

From the viewpoint of the chroma of the secondary color, the content of the fluorescent colorant is, for example, preferably 1% by mass or more and 19.9% by mass or less, more preferably 0.3% by mass or more and 18% by mass or less, and particularly preferably 5% by mass or more and 15% by mass or less with respect to the total mass of the toner particles.

The image forming apparatus according to the present exemplary embodiment may have another image forming unit that forms another toner image by using a toner other than the toner having the first fluorescent color and the toner having the second fluorescent color.

The image forming unit may have two or more other image forming units.

The other toner may be a toner having a fluorescent color or a color toner having non-fluorescent color.

Hereinafter, the configuration of the toner having the first fluorescent color, the toner having the second fluorescent color, and other toners used in the present exemplary embodiment will be specifically described.

In addition, in a case of simply “toner”, “toner particles”, or the like, unless otherwise specified, it is assumed that all of the toner having the first fluorescent color, the toner having the second fluorescent color, and other toners are described.

### Toner Particles

The toner particles contain a non-fluorescent colorant or a fluorescent colorant, a binder resin, and, as necessary, a release agent and other additives.

### Non-Fluorescent Colorant

The toner particles in the toner having the first fluorescent color and the toner having the second fluorescent color may contain a non-fluorescent colorant.

The toner particles in other toners may contain a non-fluorescent colorant.

The non-fluorescent colorant is not limited in color or the like as long as the non-fluorescent organic pigment is an organic pigment that does not fluoresce. Examples thereof include a non-fluorescent green organic pigment, a non-fluorescent red organic pigment, a non-fluorescent yellow organic pigment, a non-fluorescent pink organic pigment, a non-fluorescent orange organic pigment, a non-fluorescent purple organic pigment, and the like. Among these, for example, a non-fluorescent green pigment or a non-fluorescent red pigment is preferable, and a non-fluorescent green pigment is more preferable.

It is preferable that the non-fluorescent colorant has, for example, a halogen atom.

Examples of the halogen atom in the non-fluorescent colorant include a fluorine atom, a chlorine atom, a bromine atom, and an iodine atom.

Among these, the non-fluorescent colorant preferably has, for example, at least one selected from the group consisting of a chlorine atom and a bromine atom, more preferably a bromine atom, and particularly preferably a chlorine atom and a bromine atom as the halogen atom.

In addition, from the viewpoint of bending resistance and reflectance of the obtained image, for example, the non-fluorescent colorant preferably has 2 or more halogen atoms, more preferably has 4 or more halogen atoms, even more preferably has 6 or more halogen atoms, and particularly preferable has 8 or more and 32 or less halogen atoms.

Examples of the non-fluorescent colorant include a halogenated phthalocyanine compound and a lake pigment of a halogenated triphenylmethane dye.

As the non-fluorescent colorant, for example, a halogenated phthalocyanine compound is preferable, at least one kind of compound selected from the group consisting of halogenated copper phthalocyanine and halogenated zinc phthalocyanine is more preferable, and halogenated copper phthalocyanine is still more preferable.

Examples of the halogenated copper phthalocyanine include C.I. Pigment Green 7 (specific gravity 2.1, reflection peak wavelength 500 nm, having 16 chlorine atoms) and C.I. Pigment Green 36 (specific gravity 2.9, reflection peak wavelength 510 nm, having 10 chlorine atoms and 6 bromine atoms).

Examples of the non-fluorescent colorant include an anthraquinone compound.

Examples of the anthraquinone compound include C.I. Pigment Red 168 (specific gravity 2.1, having 2 bromine atoms) and C.I. Pigment Red 216 (specific gravity 2.8, having 3 bromine atoms).

The non-fluorescent colorant is, for example, preferably at least one kind of pigment selected from the group consisting of C.I. Pigment Green 7, C.I. Pigment Green 36, C.I. Pigment Red 168, and C.I. Pigment Red 216, and more preferably at least one kind of pigment selected from the group consisting of C.I. Pigment Green 36 and C.I. Pigment Red 216.

From the viewpoint of achieving the reflectance of the obtained image, dispersibility in the toner particles, color showing properties on a recording medium, fixing properties on a recording medium, and the like in a well-balanced manner, a volume-average particle size D50v of the non-fluorescent colorant is, for example, preferably 50 nm or more and 500 nm or less, more preferably 80 nm or more and 400 nm or less, even more preferably 100 nm or more and 300 nm or less, and particularly preferably 120 nm or more and 200 nm or less.

The toner particles may contain one kind of non-fluorescent colorant alone or two or more kinds of non-fluorescent colorants.

The content of the non-fluorescent colorant is, for example, preferably 0.1% by mass or more and 19.9% by mass or less, more preferably 0.5% by mass or more and 15% by mass or less, even more preferably 1% by mass or more and 10% by mass or less, and particularly preferably 2% by mass or more and 8% by mass or less with respect to the total amount of the toner particles.

### Binder Resin

Examples of the binder resin include vinyl-based resins including a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (for example, acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binder resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binder resins may be used alone, or two or more kinds of these binder resins may be used in combination.

As the binder resin, for example, a polyester resin is suitable.

Examples of the polyester resin include known polyester resins.

Examples of the polyester resin include a polycondensate of a polyvalent carboxylic acid and a polyhydric alcohol. As the polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, phthalic acid, naphthalenedicarboxylic acid, and the like), anhydrides of these, and lower alkyl esters (for example, having 1 or more and 5 or less carbon atoms). Among the above, for example, aromatic dicarboxylic acids are preferable as the polyvalent carboxylic acid.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having a valency of 3 or more and a crosslinked structure or a branched structure may be used in combination with a diol. Examples of the polyhydric alcohol having a valency of 3 or more include glycerin, trimethylolpropane, and pentaerythritol.

One kind of polyhydric alcohol may be used alone, or two or more kinds of polyhydric alcohols may be used in combination.

A glass transition temperature (Tg) of the polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

A weight-average molecular weight (Mw) of the polyester resin is, for example, preferably 5,000 or more and 1,000,000 or less, and more preferably 7,000 or more and 500,000 or less.

A number-average molecular weight (Mn) of the polyester resin is, for example, preferably 2,000 or more and 100,000 or less.

A molecular weight distribution Mw/Mn of the polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC. HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

The polyester resin is obtained by a known producing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

In a case where monomers as raw materials are not dissolved or compatible at the reaction temperature, in order to dissolve the monomers, a solvent having a high boiling point may be added as a solubilizer. In this case, a polycondensation reaction is carried out in a state where the solubilizer is distilled off. In a case where a monomer with poor compatibility takes part in the reaction, for example, the monomer with poor compatibility may be condensed in advance with an acid or an alcohol that is to be polycondensed with the monomer, and then polycondensed together with the main component.

The content of the binder resin with respect to the total amount of the toner particles is, for example, preferably 40% by mass or more and 95% by mass or less, more preferably 50% by mass or more and 90% by mass or less, and even more preferably 60% by mass or more and 85% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. The release agent is not limited to the agents.

The melting temperature of the release agent is, for example, preferably 50° C. or higher and 110° C. or lower, and more preferably 60° C. or higher and 100° C. or lower.

The melting temperature is determined from a DSC curve obtained by differential scanning calorimetry (DSC) by “peak melting temperature” described in the method for determining the melting temperature in JIS K7121-1987, “Testing methods for transition temperatures of plastics”.

The content of the release agent with respect to the total amount of the toner particles is, for example, preferably 1% by mass or more and 20% by mass or less, and more preferably 5% by mass or more and 15% by mass or less.

### Other Additives

Examples of other additives include known additives such as a magnetic material, an antistatic agent, and inorganic powder. The additives are incorporated into the toner particles as internal additives.

### Characteristics and the Like of Toner Particles

The toner particles may be toner particles that have a single-layer structure or toner particles having a so-called core/shell structure that is configured with a core portion (core particle) and a coating layer (shell layer) coating the core portion.

The toner particles having a core/shell structure may, for example, be configured with a core portion that is configured with a binder resin and other additives used as necessary, such as a colorant and a release agent, and a coating layer that is configured with a binder resin.

The volume-average particle size (D50v) of the toner particles is, for example, preferably 2 μm or more and 10 μm or less, and more preferably 4 μm or more and 8 μm or less.

The various average particle sizes and various particle size distribution indexes of the toner particles are measured using COULTER MULTISIZER II (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% by mass aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle size in a range of 2 μm or more and 60 μm or less is measured using COULTER MULTISIZER II with an aperture having an aperture size of 100 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume-based particle size D16v and a number-based particle size D16p. The particle size at which the cumulative percentage of particles is 50% is defined as volume-average particle size D50v and a cumulative number-average particle size D50p. The particle size at which the cumulative percentage of particles is 84% is defined as volume-based particle size D84v and a number-based particle size D84p.

By using these, a volume particle size distribution index (GSDv) is calculated as (D84v/D16v)^{1/2}, and a number particle size distribution index (GSDp) is calculated as (D84p/D16p)^{1/2}.

The average circularity of the toner particles is, for example, preferably 0.94 or more and 1.00 or less, and more preferably 0.95 or more and 0.98 or less.

The average circularity of the toner particles is determined by (equivalent circular perimeter length)/(perimeter length) [(perimeter length of circle having the same projected area as particle image)/(perimeter length of particle projection image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (FPIA-3000 manufactured by Sysmex Corporation) performing image analysis on the particle image, the average circularity is determined. The number of samplings for determining the average circularity is 3,500.

In a case where a toner contains external additives, the toner (developer) as a measurement target is dispersed in water containing a surfactant, then the dispersion is treated with ultrasonic waves such that the external additives are removed, and the toner particles are obtained.

### External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobic treatment. The hydrophobic treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

The amount of the hydrophobizing agent is, for example, preferably 1 part by mass or more and 10 parts by mass or less with respect to 100 parts by mass of the inorganic particles.

Examples of the external additive also include resin particles (resin particles such as polystyrene, polymethyl methacrylate, and melamine resins), a cleaning activator (for example, and a metal salt of a higher fatty acid represented by zinc stearate or fluorine-based polymer particles).

The amount of the external additive externally added with respect to the toner particles is, for example, preferably 0.01% by mass or more and 5% by mass or less, and more preferably 0.01% by mass or more and 2.0% by mass or less.

### Manufacturing Method of Toner

The toner used in the present exemplary embodiment is obtained by manufacturing toner particles and then adding external additives to the exterior of the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). These manufacturing methods are not particularly limited, and known manufacturing methods are adopted. Among the above methods, for example, the aggregation and coalescence method may be used for obtaining toner particles.

In a case where the toner particles of the toner having the first fluorescent color and toner having the second fluorescent color are produced by the aggregation and coalescence method, for example, the following manufacturing method is preferable.

The manufacturing method including
a step of preparing a resin particle dispersion in which resin particles serving as a binder resin are dispersed (resin particle dispersion-preparing step),
a step of preparing a fluorescent colorant dispersion in which a fluorescent colorant is dispersed (fluorescent colorant dispersion-preparing step),
a step of preparing a non-fluorescent colorant dispersion in which the non-fluorescent colorant is dispersed (non-fluorescent colorant dispersion-preparing step),
a step of aggregating the mixed particles in a mixed dispersion obtained by mixing the resin particle dispersion, the fluorescent colorant dispersion, and the non-fluorescent colorant dispersion to form aggregated particles (aggregated particle-forming step), and
a step of coalescing the aggregated particles by heating an aggregated particle dispersion, in which the aggregated particles are dispersed, to form toner particles (coalescence step).

Hereinafter, each of the steps will be specifically described.

### Resin Particle Dispersion—Preparing Step

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having a medium, a sand mill, and a dyno mill. Depending on the type of resin particles, the resin particles may be dispersed in the dispersion medium by using a transitional phase-transfer emulsification method. The transitional phase-transfer emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes phase transition from W/O to O/W and is dispersed in the aqueous medium in a particulate form.

The volume-average particle size of the resin particles dispersed in the resin particle dispersion is, for example, preferably 0.01 μm or more and 1 μm or less, more preferably 0.08 μm or more and 0.8 μm or less, and even more preferably 0.1 μm or more and 0.6 μm or less. For determining the volume-average particle size of the resin particles, a particle size distribution is measured using a laser diffraction-type particle size distribution analyzer (for example, LA-700 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume-average particle size D50v. For particles in other dispersions, the volume-average particle size is measured in the same manner.

The content of the resin particles contained in the resin particle dispersion is, for example, preferably 5% by mass or more and 50% by mass or less, and more preferably 10% by mass or more and 40% by mass or less.

The method of preparing a release agent particle dispersion is the same as the method of preparing the resin particle dispersion. The content of the release agent particles contained in the release agent particle dispersion is, for example, preferably 5% by mass or more and 50% by mass or less, and more preferably 10% by mass or more and 40% by mass or less.

### Fluorescent Colorant Dispersion—Preparing Step

The fluorescent colorant dispersion is prepared, for example, by dispersing the fluorescent colorant in a dispersion medium by using a surfactant.

Examples of the dispersion medium used for the fluorescent colorant dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

Examples of the method of dispersing the fluorescent colorant in a dispersion medium include dispersion methods using a rotary shearing homogenizer, a ball mill having media, a sand mill, a dyno mill, a key mill, and the like.

The volume-average particle size of the fluorescent colorant dispersed in the fluorescent colorant dispersion is, for example, preferably 50 nm or more and 800 nm or less, more preferably 150 nm or more and 600 nm or less, and even more preferably 250 nm or more and 400 nm or less. The particle size of the fluorescent colorant is adjusted by, for example, the method and time of the dispersion treatment.

The content of the fluorescent colorant contained in the fluorescent colorant dispersion is, for example, preferably 5% by mass or more and 50% by mass or less, and more preferably 10% by mass or more and 40% by mass or less.

### Non-Fluorescent Colorant Dispersion—Preparing Step

The non-fluorescent colorant dispersion is prepared, for example, by dispersing the non-fluorescent colorant in a dispersion medium by using a surfactant.

Examples of the dispersion medium used for the non-fluorescent colorant dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

Examples of the method of dispersing the non-fluorescent colorant in a dispersion medium include dispersion methods using a rotary shearing homogenizer, a ball mill having media, a sand mill, a dyno mill, a key mill, and the like.

The volume-average particle size of the non-fluorescent colorant to be dispersed in the non-fluorescent colorant dispersion is, for example, preferably 50 nm or more and 300 nm or less, more preferably 100 nm or more and 250 nm or less, and even more preferably 120 nm or more and 200 nm or less. The particle size of the non-fluorescent colorant is adjusted by, for example, the method and time of the dispersion treatment.

The content of the non-fluorescent colorant contained in the non-fluorescent colorant dispersion is, for example, preferably 5% by mass or more and 50% by mass or less, and more preferably 10% by mass or more and 40% by mass or less.

### Aggregated Particle—Forming Step

The resin particle dispersion, the fluorescent colorant dispersion, the non-fluorescent colorant dispersion, and the release agent particle dispersion are mixed together. Thereafter, in the mixed dispersion, the resin particles, the fluorescent colorant, the non-fluorescent colorant, and the release agent particles are hetero-aggregated such that aggregated particles are formed which have a diameter close to the diameter of the target toner particles and include the resin particles, the fluorescent colorant, the non-fluorescent colorant, and the release agent particles.

Specifically, for example, an aggregating agent is added to the mixed dispersion, the pH of the mixed dispersion is adjusted such that the dispersion is acidic (for example, pH of 2 or more and 5 or less), and a dispersion stabilizer is added thereto as necessary. Thereafter, the dispersion is heated to a temperature of the glass transition temperature of the resin particles (specifically, for example, to a temperature equal to or higher than the glass transition temperature of the resin particles −30° C. and equal to or lower than the glass transition temperature of the resin particles −10° C.) such that the particles dispersed in the mixed dispersion are aggregated, thereby forming aggregated particles.

In the aggregated particle-forming step, for example, in a state where the mixed dispersion is agitated with a rotary shearing homogenizer, the aggregating agent may be added thereto at room temperature (for example, 25° C.), the pH of the mixed dispersion may be adjusted such that the dispersion is acidic (for example, pH of 2 or more and 5 or less), a dispersion stabilizer may be added to the dispersion as necessary, and then the dispersion may be heated.

Examples of the aggregating agent include a surfactant having polarity opposite to the polarity of the surfactant contained in the mixed dispersion, an inorganic metal salt, and a metal complex having a valency of 2 or more. In a case where a metal complex is used as the aggregating agent, the amount of the surfactant used is reduced, and the charging characteristics are improved.

In addition to the aggregating agent, an additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid; and aminocarboxylic acids such as iminodiacetic acid (IDA), nitrilotriacetic acid (NTA), and ethylenediaminetetraacetic acid (EDTA).

An amount of the chelating agent added with respect to 100 parts by mass of the resin particles is, for example, preferably 0.01 parts by mass or more and 5.0 parts by mass or less, and more preferably 0.1 parts by mass or more and less than 3.0 parts by mass.

### Coalescence Step

The aggregated particle dispersion in which the aggregated particles are dispersed is then heated to, for example, a temperature equal to or higher than the glass transition temperature of the resin particles (for example, a temperature higher than the glass transition temperature of the resin particles by 10° C. to 30° C.) such that the aggregated particles coalesce, thereby forming toner particles.

Toner particles are obtained through the above steps.

The toner particles may be manufactured through a step of obtaining an aggregated particle dispersion in which the aggregated particles are dispersed, then mixing the aggregated particle dispersion with a resin particle dispersion in which resin particles are dispersed to cause the resin particles to be aggregated and adhere to the surface of the aggregated particles and to form second aggregated particles, and a step of heating a second aggregated particle dispersion in which the second aggregated particles are dispersed to cause the second aggregated particles to coalesce and to form toner particles having a core/shell structure.

After the coalescence step ends, the toner particles in the dispersion are subjected to known washing step, solid-liquid separation step, and drying step, thereby obtaining dry toner particles. As the washing step, from the viewpoint of charging properties, for example, displacement washing may be thoroughly performed using deionized water. As the solid-liquid separation step, from the viewpoint of productivity, for example, suction filtration, pressure filtration, or the like may be performed. As the drying step, from the viewpoint of productivity, for example, freeze drying, flush drying, fluidized drying, vibratory fluidized drying, or the like may be performed.

For example, by adding an external additive to the obtained dry toner particles and mixing the external additive and the toner particles together, the toner used in the present exemplary embodiment is manufactured. The mixing may be performed, for example, using a V blender, a Henschel mixer, a Lödige mixer, or the like. Furthermore, coarse particles of the toner may be removed as necessary by using a vibratory sieving machine, a pneumatic sieving machine, or the like.

### Electrostatic Charge Image Developer

The electrostatic charge image developer used in the present exemplary embodiment contains at least the toner having the first fluorescent color according to the present exemplary embodiment, the toner having the second fluorescent color according to the present exemplary embodiment, or other toner.

The electrostatic charge image developer used in the present exemplary embodiment may be a one-component developer that contains only the toner or a two-component developer that is obtained by mixing the toner and a carrier together.

The carrier is not particularly limited, and examples thereof include known carriers. Examples of the carrier include a coated carrier obtained by coating the surface of a core material containing magnetic powder with a resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating the surface of a core material, which are particles configuring the carrier, with a resin.

Examples of the magnetic powder include magnetic metals such as iron, nickel, and cobalt; and magnetic oxides such as ferrite and magnetite.

Examples of the coating resin and matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene/acrylic acid ester copolymer, a straight silicone resin configured with an organosiloxane bond, a product obtained by modifying the straight silicone resin, a fluororesin, polyester, polycarbonate, a phenol resin, and an epoxy resin. The coating resin and the matrix resin may contain other additives such as conductive particles. Examples of the conductive particles include metals such as gold, silver, and copper, and particles such as carbon black, titanium oxide, zinc oxide, tin oxide, barium sulfate, aluminum borate, and potassium titanate.

The surface of the core material is coated with a resin, for example, by a coating method using a solution for forming a coating layer obtained by dissolving the coating resin and various additives (used as necessary) in an appropriate solvent, and the like. The solvent is not particularly limited, and may be selected in consideration of the type of the resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and then removing solvents.

The mixing ratio (mass ratio) between the toner and the carrier, represented by toner:carrier, in the two-component developer is, for example, preferably 1:100 to 30:100, and more preferably 3:100 to 20:100.

### Each Means

The image forming apparatus according to the present exemplary embodiment includes a first image forming unit that forms a first toner image by using a toner having a first fluorescent color, a second image forming unit that forms a second toner image by using a toner having a second fluorescent color, and a transfer unit that transfers the first toner image to a recording medium by superimposing the first toner image on the second toner image such that the first toner image is located above the second toner image on the recording medium.

As the first image forming unit and the second image forming unit, known image forming units can be used except that the toner having the first fluorescent color or the toner having the second fluorescent color is used.

Examples of the image forming unit include means having an image holder, charging means that charges the surface of the image holder, an electrostatic charge image forming unit that forms an electrostatic charge image on the charged surface of the image holder, and developing means that contains an electrostatic charge image developer and develops the electrostatic charge image formed on the surface of the image holder as a toner image by using the electrostatic charge image developer.

As the transfer unit, a known transfer unit can be used, except that the first toner image is transferred to the recording medium by being superimposed on the second toner image such that the first toner image is located above the second toner image on the recording medium.

Further, the image forming apparatus according to the present exemplary embodiment preferably includes, for example, fixing means that fixes the toner image transferred to the surface of the recording medium.

Further, the image forming apparatus according to the present exemplary embodiment may have other known means.

In the image forming apparatus according to the present exemplary embodiment, an image forming method (image forming method according to the present exemplary embodiment) is performed, the method including a first image forming step of forming a first toner image by using a toner having a first fluorescent color, a second image forming step of forming a second toner image by using a toner having a second fluorescent color, and a transferring step of transferring the first toner image to a recording medium by superimposing the first toner image on the second toner image such that the first toner image is located above the second toner image on the recording medium, in which a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

As the image forming apparatus according to the present exemplary embodiment, known image forming apparatuses are used, such as a direct transfer-type apparatus that transfers a toner image formed on the surface of the image holder directly to a recording medium; an intermediate transfer-type apparatus that performs primary transfer by which the toner image formed on the surface of the image holder is transferred to the surface of an intermediate transfer member and secondary transfer by which the toner image transferred to the surface of the intermediate transfer member is transferred to the surface of a recording medium; an apparatus including cleaning means that cleans the surface of the image holder before charging after the transfer of the toner image; and an apparatus including charge neutralization means that neutralizes charge by irradiating the surface of the image holder with charge neutralizing light before charging after the transfer of the toner image.

In the case where the image forming apparatus according to the present exemplary embodiment is the intermediate transfer-type apparatus, for example, a configuration of the transfer unit is adopted which has an intermediate transfer member with surface on which the toner image will be transferred, a primary transfer unit that performs primary transfer to transfer the toner image formed on the surface of the image holder to the surface of the intermediate transfer member, and a secondary transfer unit that performs secondary transfer to transfer the toner image transferred to the surface of the intermediate transfer member to the surface of a recording medium.

In the image forming apparatus according to the present exemplary embodiment, for example, a portion including the developing means may be a cartridge structure (process cartridge) detachable from the image forming apparatus. As the process cartridge, for example, a process cartridge is preferably used that includes a developing unit that contains the electrostatic charge image developer.

An example of the image forming apparatus according to the present exemplary embodiment will be shown below, but the present exemplary embodiment is not limited thereto. Hereinafter, among the parts shown in the drawings, main parts will be described, and others will not be described.

In the following section, as an example of the image forming apparatus according to the present exemplary embodiment, a 6-unit tandem image forming apparatus having an array of 6 image forming units will be described. The tandem image forming apparatus is not limited to this, and may be a 5-unit tandem image forming apparatus having an array of 5 image forming units, a 4-unit tandem image forming apparatus having an array of 4 image forming units, or the like.

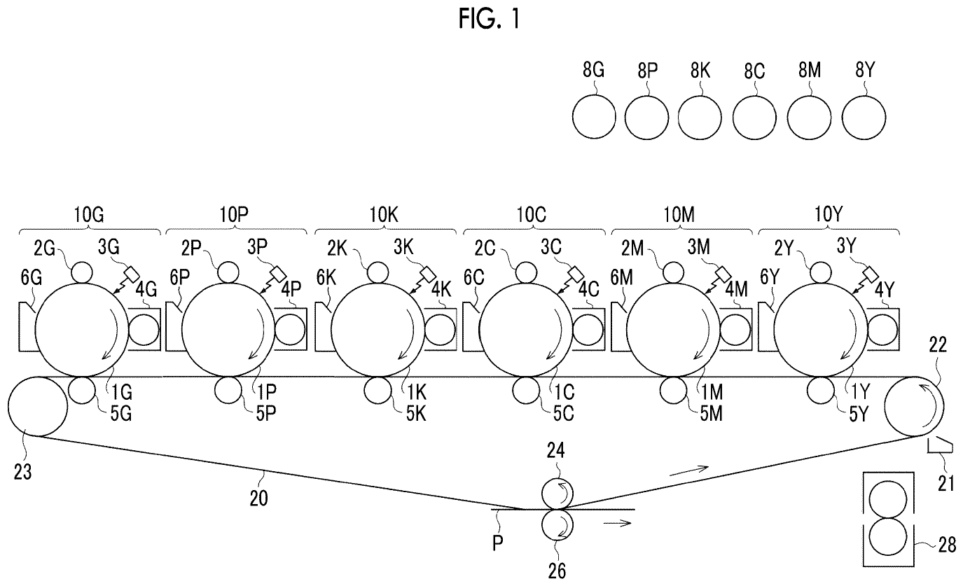

FIG. 1 is a view schematically showing the configuration of the image forming apparatus according to the present exemplary embodiment, which shows an intermediate transfer-type 6-unit tandem image forming apparatus.

The image forming apparatus shown in FIG. 1 includes first to sixth image forming units 10Y, 10M, 10C, 10K, 10P, and 10G as electrophotographic image forming units that print out images of colors, pink (P), yellow (Y), magenta (M), cyan (C), black (K), and green (G) based on color-separated image data. These image forming units (hereinafter, simply called “units” in some cases) 10Y, 10M, 10C, 10K, 10P, and 10G are arranged in a row in the horizontal direction in a state of being spaced apart by a predetermined distance. The units 10Y, 10M, 10C, 10K, 10P, and 10G may be process cartridges that are detachable from the image forming apparatus.

An intermediate transfer belt (an example of an intermediate transfer member) 20 passing through the units 10Y, 10M, 10C, 10K, 10P, and 10G extends under the units. The intermediate transfer belt 20 is looped around a driving roll 22, a support roll 23, and an opposing roll 24 that are in contact with the inner surface of the intermediate transfer belt 20, and runs toward a sixth unit 10G from a first unit 10P. An intermediate transfer member cleaning device 21 facing the driving roll 22 is provided on the side of an image holding surface of the intermediate transfer belt 20.

Toners of pink, yellow, magenta, cyan, black, and green stored in containers of the toner cartridges 8Y, 8M, 8C, 8K, 8P, and 8G are supplied to developing devices (an example of developing units) 4Y, 4M, 4C, 4K, 4P, and 4G of units 10Y, 10M, 10C, 10K, 10P, and 10G respectively.

The first to sixth units 10Y, 10M, 10C, 10K, 10P, and 10G have the same configuration and perform the same operation. Therefore, in the present specification, as a representative, the sixth unit 10G that forms a green image will be described.

The sixth unit 10G has a photoreceptor 1G that acts as an image holder. Around the photoreceptor 1G, a charging roll 2G (an example of charging means) that charges the surface of the photoreceptor 1G at a predetermined potential, an exposure device 3G (an example of electrostatic charge image forming unit) that exposes the charged surface to a laser beam based on color-separated image signals to form an electrostatic charge image, a developing device 4G (an example of developing means) that develops the electrostatic charge image by supplying a toner to the electrostatic charge image, a primary transfer roll 5G (an example of primary transfer unit) that transfers the developed toner image onto the intermediate transfer belt 20, and a photoreceptor cleaning device 6G (an example of cleaning means) that removes the residual toner on the surface of the photoreceptor 1G after the primary transfer are arranged in this order.

The primary transfer roll 5G is disposed on the inner side of the intermediate transfer belt 20, at a position facing the photoreceptor 1G. A bias power supply (not shown in the drawing) for applying a primary transfer bias is connected to primary transfer rolls 5Y, 5M, 5C, 5K, 5P, and 5G of each unit. Each bias power supply changes a value of the transfer bias applied to each primary transfer roll under the control of a control unit not shown in the drawing.

Hereinafter, the operation that the sixth unit 10G carries out to form a green image will be described.

First, prior to the operation, the surface of the photoreceptor 1G is charged to a potential of −600 V to −800 V by the charging roll 2G.

The photoreceptor 1G is formed of a photosensitive layer laminated on a conductive (for example, volume resistivity at 20° C.: 1×10⁻⁶ Ω·cm or less) substrate. The photosensitive layer has properties in that although this layer usually has a high resistance (resistance of a general resin), in a case where the photosensitive layer is irradiated with the laser beam, the specific resistance of the portion irradiated with the laser beam changes. Therefore, from the exposure device 3G, the laser beam is radiated to the surface of the charged photoreceptor 1G according to the image data for green transmitted from the control unit not shown in the drawing. As a result, an electrostatic charge image of the green image pattern is formed on the surface of the photoreceptor 1G.

The electrostatic charge image is an image formed on the surface of the photoreceptor 1G by charging. This image is a so-called negative latent image formed in a manner in which the charges with which the surface of the photoreceptor 1G is charged flow due to the reduction in the specific resistance of the portion of the photosensitive layer irradiated with the laser beam from the exposure device 3G, but the charges in a portion not being irradiated with the laser beam remain.

The electrostatic charge image formed on the photoreceptor 1G rotates to a predetermined development position as the photoreceptor 1G runs. At the development position, the electrostatic charge image on the photoreceptor 1G is developed as a toner image by the developing device 4G and visualized.

The developing device 4G contains, for example, an electrostatic charge image developer that contains at least a green toner and a carrier. By being agitated in the developing device 4G, the green toner undergoes triboelectrification, carries charges of the same polarity (negative polarity) as the charges with which the surface of the photoreceptor 1G is charged, and is held on a developer roll (an example of a developer holder). Then, as the surface of the photoreceptor 1G passes through the developing device 4G, the green toner electrostatically adheres to the neutralized latent image portion on the surface of the photoreceptor 1G, and the latent image is developed by the green toner. The photoreceptor 1G on which the green toner image is formed keeps on running at a predetermined speed, and the toner image developed on the photoreceptor 1G is transported to a predetermined primary transfer position.

In a case where the green toner image on the photoreceptor 1G is transported to the primary transfer position, a primary transfer bias is applied to the primary transfer roll 5G, and electrostatic force heading for the primary transfer roll 5G from the photoreceptor 1G acts on the toner image. As a result, the toner image on the photoreceptor 1G is transferred onto the intermediate transfer belt 20. The transfer bias applied at this time has a polarity (+) opposite to the polarity (−) of the toner. In the sixth unit 10G, the transfer bias is set, for example, to +10 μA under the control of the control unit (not shown in the drawing).

The photoreceptor 1G having transferred the toner image to the intermediate transfer belt 20 keeps rotating to come into contact with a cleaning blade included in the photoreceptor cleaning device 6G. The residual toner on the photoreceptor 1G is removed by the photoreceptor cleaning device 6G and collected.

The intermediate transfer belt 20 is sequentially transported through the first to sixth image forming units 10Y, 10M, 10C, 10K, 10P, and 10G, and the toner images of each color are superposed and transferred in layers.

The intermediate transfer belt 20, to which the toner images of six colors are transferred in layers through the first to six units, reaches a secondary transfer portion configured with the intermediate transfer belt 20, the opposing roll 24 in contact with the inner surface of the intermediate transfer belt, and a secondary transfer roll 26 (an example of a secondary transfer unit) disposed on the image holding surface side of the intermediate transfer belt 20. On the other hand, through a supply mechanism, recording paper P (an example of recording medium) is supplied at a predetermined timing to the gap between the secondary transfer roll 26 and the intermediate transfer belt 20 that are in contact with each other. Furthermore, secondary transfer bias is applied to the opposing roll 24. The transfer bias applied at this time has the same polarity (−) as the polarity (−) of the toner. The electrostatic force heading for the recording paper P from the intermediate transfer belt 20 acts on the toner image, which makes the toner image on the intermediate transfer belt 20 transferred onto the recording paper P. The secondary transfer bias to be applied at this time is determined according to the resistance detected by resistance detecting means (not shown in the drawing) for detecting the resistance of the secondary transfer portion, and the voltage thereof is controlled.

The intermediate transfer belt 20 having transferred the toner image to the recording paper P keeps running to come into contact with a cleaning blade included in the intermediate transfer member cleaning device 21. The residual toner on the intermediate transfer belt 20 is removed by the intermediate transfer member cleaning device 21 and collected.

The recording paper P on which the toner image has been transferred is transported into a pressure contact portion (nip portion) of a pair of fixing rolls in a fixing device 28 (an example of fixing means), the toner image is fixed to the surface of the recording paper P, and a fixed image is formed.

Examples of the recording paper P to which the toner image is to be transferred include plain paper used in electrophotographic copy machines, printers, and the like. Examples of the recording medium also include an OHP sheet, in addition to the recording paper P.

In order to further improve the smoothness of the image surface after fixing, for example, it is suitable that the surface of the recording paper P is also smooth. For example, coated paper prepared by coating the surface of plain paper with a resin or the like, art paper for printing, and the like are suitably used.

The recording paper P on which the colored image has been fixed is transported to an output portion, and a series of colored image forming operations is finished.

The process cartridge used in the present exemplary embodiment will be described.

The process cartridge used in the present exemplary embodiment includes a developing unit that contains the electrostatic charge image developer according to the present exemplary embodiment and develops an electrostatic charge image formed on the surface of an image holder as a toner image by using the electrostatic charge image developer. The process cartridge is detachable from the image forming apparatus.

The process cartridge used in the present exemplary embodiment is not limited to the above configuration. The process cartridge may be configured with developing means and, for example, at least one member selected from other means, such as an image holder, charging means, an electrostatic charge image forming unit, and a transfer unit, as necessary.

An example of the process cartridge used in the present exemplary embodiment will be shown below, but the present invention is not limited thereto. Hereinafter, among the parts shown in the drawings, main parts will be described, and others will not be described.

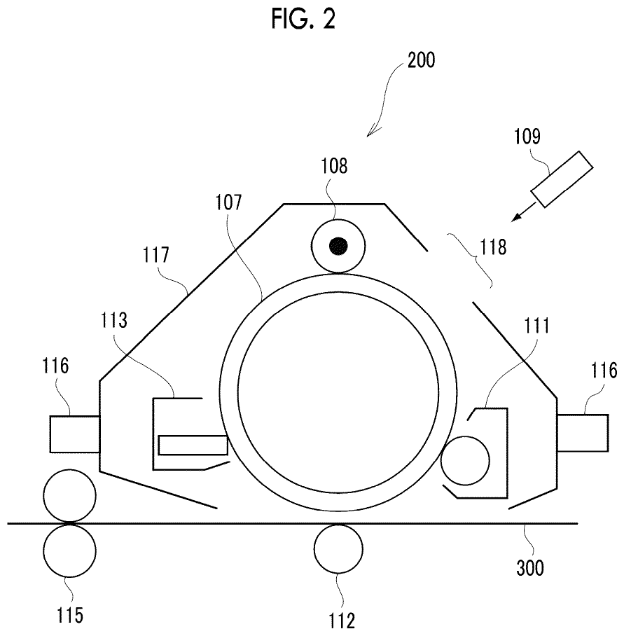

FIG. 2 is a view schematically showing the configuration of the process cartridge used in the present exemplary embodiment.

A process cartridge 200 shown in FIG. 2 is configured, for example, with a housing 117 that includes mounting rails 116 and an opening portion 118 for exposure, a photoreceptor 107 (an example of image holder), a charging roll 108 (an example of charging means) that is provided on the periphery of the photoreceptor 107, a developing device 111 (an example of developing means), a photoreceptor cleaning device 113 (an example of cleaning means), which are integrally combined and held in the housing 117. The process cartridge 200 forms a cartridge in this way.

In FIG. 2, 109 indicates an exposure device (an example of electrostatic charge image forming unit), 112 indicates a transfer device (an example of transfer unit), 115 indicates a fixing device (an example of fixing means), and 300 indicates recording paper (an example of recording medium).

Next, the toner cartridge used in the present exemplary embodiment will be described.

The toner cartridge used in the present exemplary embodiment is a toner cartridge including a container that contains the toner and is detachable from the image forming apparatus. The toner cartridge includes a container that contains a replenishing toner to be supplied to the developing means provided in the image forming apparatus.

The image forming apparatus shown in FIG. 1 is an image forming apparatus having a configuration that enables toner cartridges 8Y, 8M, 8C, 8K, 8P, and 8G to be detachable from the apparatus. The developing devices 4Y, 4M, 4C, 4K, 4P, and 4G are connected to toner cartridges corresponding to the respective colors by a toner supply pipe not shown in the drawing. In addition, in a case where the amount of the toner contained in the container of the toner cartridge is low, the toner cartridge is replaced. The toner cartridge 8G is an example of the toner cartridge used in the present exemplary embodiment, and has a container that contains the fluorescent green toner. The toner cartridges 8Y, 8M, 8C, 8K, and 8P have containers that contain yellow, magenta, cyan, black, and fluorescent pink toners respectively.

### EXAMPLES

Hereinafter, exemplary embodiments of the present invention will be specifically described based on examples. However, the exemplary embodiments of the present invention are not limited to the examples.

In the following description, unless otherwise specified, “parts” and “%” are based on mass.

Unless otherwise specified, synthesis, treatment, manufacturing, and the like are carried out at room temperature (25° C.±3° C.).

### Example 1

### Preparation of Colorant Particle Dispersion (1)

Fluorescent yellow pigment (C.I. Pigment Yellow 101 (manufactured by Radiant Color, Radglo VSF-0-01, emission peak wavelength 520 nm)): 70 parts
Anionic surfactant (manufactured by DKS Co., Ltd., NEOGEN RK): 30 parts (concentration of solid content 20%)·
Deionized water: 200 parts

The above components are mixed together and pulverized with a continuous key mill (KMC-3) to 0.5 μm, and the amount of solid content is adjusted to 20% by mass, thereby obtaining a colorant particle dispersion (1).

### Preparation of Colorant Particle Dispersion (2)

Non-fluorescent green pigment (C.I. Pigment Green 36 (manufactured by TOYOCOLOR CO., LTD., LIONOL GREEN 8624, reflection peak wavelength 510 nm)): 70 parts
Anionic surfactant (manufactured by DKS Co., Ltd., NEOGEN RK): 30 parts (concentration of solid content 20%)
Deionized water: 200 parts

The above components are mixed together and pulverized with a continuous key mill (KMC-3) to 0.2 μm, and the amount of solid content is adjusted to 20% by mass, thereby obtaining a colorant particle dispersion (2).

### Preparation of Resin Particle Dispersion (1)

Terephthalic acid: 30 parts by mole
Fumaric acid: 70 parts by mole
Ethylene oxide adduct of bisphenol A: 5 parts by mole
Propylene oxide adduct of bisphenol A: 95 parts by mole The above materials are put in a flask equipped with a stirrer, a nitrogen introduction tube, a temperature sensor, and a rectifying column, the temperature is raised to 220° C. for an hour, and titanium tetraethoxide is added thereto in an amount of 1 part with respect to 100 parts of the above materials. While the generated water is distilled off, the temperature is raised to 230° C. over 30 minutes, a dehydration condensation reaction is continued for 1 hour at the above-described temperature, and then the reaction product is cooled. In this manner, a polyester resin having a weight-average molecular weight of 18,000 and a glass transition temperature of 60° C. is obtained.

40 parts of Ethyl acetate and 25 parts of 2-butanol are put in a container equipped with temperature control means and nitrogen purge means, thereby preparing a mixed solvent. Then, 100 parts of the polyester resin is slowly added to and dissolved in the solvent, a 10% by mass aqueous ammonia solution (in an amount equivalent to 3 times the acid value of the resin in terms of molar ratio) is added thereto, and the mixed solution is stirred for 30 minutes. Next, the inside of the vessel was replaced with dry nitrogen, the temperature was kept at 40° C., and 400 parts of deionized water was added dropwise to the mixed solution at a rate of 2 parts/min while agitating the mixed solution. After the dropwise addition is completed, the temperature is returned to room temperature (20° C. to 25° C.), and bubbling is performed under agitating for 48 hours using dry nitrogen, thereby obtaining a resin particle dispersion in which the concentration of ethyl acetate and 2-butanol is reduced to 1,000 ppm or less. Deionized water is added to the above-described resin particle dispersion to adjust the solid content to 20% by mass, thereby obtaining a resin particle dispersion (1).

### Preparation of Release Agent Particle Dispersion (1)

Paraffin wax (manufactured by NIPPON SEIRO CO., LTD., HNP-9): 100 parts
Anionic surfactant (manufactured by DKS Co., Ltd., NEOGEN RK): 1 part
Deionized water: 350 parts

The above materials are mixed together, heated to 100° C., and dispersed using a homogenizer (IKA, trade name: ULTRA-TURRAX T50). Then, by using Munton Gorlin high-pressure homogenizer (Gorlin), dispersion treatment is performed, thereby obtaining a release agent particle dispersion (1) (solid content of 20% by mass) in which release agent particles having a volume-average particle size of 200 nm are dispersed.

### Production of Toner Particles (1)

Resin particle dispersion (1): 400 parts
Colorant particle dispersion (1): 50 parts
Colorant particle dispersion (2): 25 parts
Release agent particle dispersion (1): 25 parts
Anionic surfactant (manufactured by DKS Co., Ltd., NEOGEN RK, 20%): 10 parts

The above-described materials are charged into a round stainless flask, 0.1 N (=mol/L) nitric acid is added thereto to adjust the pH to 3.5, and 30 parts of a nitric acid aqueous solution of polyaluminum chloride with a concentration of 10% by mass is added thereto. Next, the mixture is dispersed at a liquid temperature of 30° C. using a homogenizer (manufactured by IKA, trade name ULTRA-TURRAX T50), heated to 45° C. in an oil bath for heating, and retained for 30 minutes. Thereafter, 50 parts of the resin particle dispersion (1) is added thereto, the reaction solution is kept as it is for 1 hour, a 0.1N aqueous solution of sodium hydroxide is added thereto such that the pH is adjusted to 8.5, and the reaction solution is heated to 84° C. and kept as it is for 2.5 hours. Next, the reaction solution was cooled to 20° C. at a rate of 20° C./min, the solids were separated by filtration, thoroughly washed with deionized water, and dried, thereby obtaining toner particles (1). The volume-average particle size of the toner particles (1) is 5.8 μm.

### Production of Carrier 1

Ferrite particles (average particle size: 35 μm): 100 parts
Toluene: 14 parts
Polymethylmethacrylate (MMA, weight-average molecular weight: 75,000): 5 parts
Carbon black: 0.2 parts (VXC-72, manufactured by Cabot Corporation., volume resistivity: 100 Ω·cm or less)

The above-described materials excluding the ferrite particles are dispersed with a sand mill, thereby preparing a dispersion. The dispersion is put in a vacuum deaerating kneader together with the ferrite particles, and dried under reduced pressure while being agitated, thereby obtaining a carrier 1.

### Production of Toner

1.5 parts by mass of hydrophobic silica (manufactured by Nippon Aerosil Co., Ltd., RY50) and 1.0 part by mass of hydrophobic titanium oxide (manufactured by Nippon Aerosil Co., Ltd., T805) with respect to 100 parts by mass of the obtained toner particles (1) were mixed and blended together for 30 seconds using a sample mill with 10,000 rpm (revolutions per minute). Then, the obtained mixture is sieved using a vibration sieve having an opening size of 45 μm, thereby preparing a toner 1 (electrostatic charge image developing toner). The volume-average particle size of the obtained toner B1 is 5.8 μm.

### Production of Electrostatic Charge Image Developer

The toner (8 parts) and 92 parts of the carrier are mixed together by using a V blender, thereby preparing a developer 1 (electrostatic charge image developer).

A toner A1 is prepared in the same manner as in the preparation of the toner B1, except that the colorant particle dispersion (3) and the colorant particle dispersion (4) are used instead of the colorant particle dispersion (1) and the colorant particle dispersion (2), and the content of the non-fluorescent colorant and the content of the fluorescent colorant are changed as listed in Table 1. Then, a developer is further obtained.

### Preparation of Colorant Particle Dispersion (3)

C.I. Basic Red 1:1 (manufactured by TANAKA CHEMICAL CORPORATION, Rhodamine 6GCP-N): 6 parts
Amorphous polyester resin (weight-average molecular weight 13,000, glass transition temperature 62° C.): 94 parts

The above materials were mixed by heating to 160° C., and after dissolving the dye in the resin, the kneaded product was rolled and cooled to 30° C. or lower. The obtained kneaded product was coarsely pulverized with a hammer mill to a size of 1 mm or less, and then finely pulverized with a jet mill (AFG, manufactured by Hosokawa Micron Group). The particles obtained by fine pulverization are mixed with 30 parts (solid content 20%) of an anionic surfactant (manufactured by DKS Co., Ltd., NEOGEN RK) and 200 parts of deionized water, and the mixture was pulverized with a continuous key mill (KMC-3, manufactured by INOUE MFG., INC.) to a volume-average particle size of 200 nm. The solid content is adjusted to 20%, thereby obtaining a colorant particle dispersion (3).

### Preparation of Colorant Particle Dispersion (4)

C.I. Pigment Red 122 (manufactured by DIC Corporation, FASTOGEN SUPER MAGENTA RFS): 70 parts
Anionic surfactant (manufactured by DKS Co., Ltd., NEOGEN RK): 30 parts (concentration of solid content 20%)
Deionized water: 200 parts of the above components are mixed together and pulverized with a continuous key mill (KMC-3) to 0.2 μm, and the amount of solid content is adjusted to 20% by mass, thereby obtaining a colorant particle dispersion (4).

### Measurement of Photoluminescent Intensity

The fluorescence spectrum of the toner image is measured with a spectrophotofluorometer (F4500 manufactured by Hitachi High-Tech Corporation).

A spectrally separated xenon lamp light source is used as the excitation light, an excitation wavelength is set to 365 nm, a fluorescence start wavelength is set to 380 nm, a fluorescence end wavelength is set to 600 nm, a scan speed is set to 240 nm/min, an excitation side slit is set to 2.5 nm, a fluorescence side slit is set to 1 nm, and a photomultiplier voltage is set to 950 V.

The height and the peak area of the peak wavelength of the fluorescence spectrum measured under the present conditions are read, and the peak area is defined as the image light emission peak area.

Further, similarly, the image light emission peak area in a case where the excitation light is not emitted is measured.

The value of the image light emission peak area in a case where the excitation light is emitted/the image light emission peak area in a case where the excitation light is not emitted is used as the photoluminescent intensity.

In addition, the unit of the photoluminescent intensity in the present exemplary embodiment is dimensionless.

### Evaluation of Chroma of Secondary Color

As an image forming apparatus for forming an evaluation image, Apeos C7070 manufactured by FUJIFILM Business Innovation Corporation. is prepared, the obtained developer is put in a developing machine, and a replenishing toner (the same toner as the toner contained in the developer) is put in a toner cartridge. Subsequently, the solid image with an image area ratio of 100% having a size of 5 cm×5 cm is output onto coated paper (OS coated paper W, manufactured by FUJIFILM Business Innovation Corporation., basis weight: 127 g/m²) by the image forming apparatus at a fixing temperature of 160° C. and a printing speed of 70 sheets/min.

As the measurement material, three types of solid images are prepared, which are a solid image of only the first fluorescent toner, a solid image of only the second fluorescent toner, and a solid image in which the first fluorescent toner as the lower layer and the second fluorescent toner as the upper layer are superimposed.

Using a reflection spectrodensitometer exact Advance (aperture diameter 4 mm, X-Rite Inc.), the L* value (brightness), a* value, and b* value in the CIE1976 L*a*b* color systems were measured at 10 places in the solid image. Further, the chroma C* is calculated from the following equation.

$$Chroma {C}^{*} = {\{ {( {a}^{*} )}^{2} + {( {b}^{*} )}^{2} \}}^{0.5}$$

The measurement is performed in the measurement illumination condition that is a condition of illumination matching the CIE illuminant D50 in M1, and that is a condition of UV removal (UV cut, no UV, UV filter) in M2, and the chroma difference (C*M1-C*M2) is calculated. The fact that the difference in chroma is large means that the fluorescent colorant sufficiently emits light and the chroma of the secondary color is improved in a daily light environment such as sunlight containing ultraviolet rays.

The evaluation standard is as follows. 2.5 or more is set as the allowable range of the color difference (practical color difference b), which can be regarded as substantially the same as that in a case where the color samples are separated and determined.
A: 5.5 or more
B: 4.0 or more and less than 5.5
C: 2.5 or more and less than 4.0
D: 0 or more and less than 2.5

### Examples 2 to 12, and Comparative Examples 1 and 2

Each toner is prepared in the same manner as in Example 1 except that the kind and the content of the non-fluorescent colorant and the kind and the content of the fluorescent colorant are changed as shown in Table 1, and then a developer is obtained. The obtained developer is evaluated in the same manner.

TABLE 1

| | Toner having | | | | | | | | |
|---|---|---|---|---|---|---|---|---|---|
| | first fluores- | | | | | | Ratio of | | |
| | cent color | | | | | | photolu- | Total of | |
| | Toner having | Fluorescent | | Non-fluorescent | | Photolu- | minescent | photolu- | |
| | second fluores- | colorant | | colorant | | minescent | intensity | minescent | Chroma |
| | cent color | Type | Amount | Type | Amount | intensity | (B/A) | intensity | difference |
| Example 1 | Fluorescent A1 | BR1:1 | 3 | PR122 | 4 | 1000 | 6.0 | 7000 | 4.5 |
| | (pink) | | | | | | | | |
| | Fluorescent B1 | PY101 | 10 | PG36 | 5 | 6000 | | | |
| | (green) | | | | | | | | |
| Example 2 | Fluorescent A2 | BR1:1 | 3 | PR122 | 2 | 2600 | 1.5 | 6600 | 3.2 |
| | (pink) | | | | | | | | |
| | Fluorescent B2 | PY101 | 10 | PG36 | 6 | 4000 | | | |
| | (green) | | | | | | | | |
| Example 3 | Fluorescent A3 | BR1:1 | 3 | PR122 | 4 | 1000 | 9.5 | 10500 | 5.4 |
| | (pink) | | | | | | | | |
| | Fluorescent B3 | PY101 | 12 | PG58 | 3 | 9500 | | | |
| | (green) | | | | | | | | |
| Example 4 | Fluorescent A1 | BR1:1 | 3 | PR122 | 3 | 2050 | 1.5 | 5150 | 3.0 |
| | (pink) | | | | | | | | |
| | Fluorescent B4 | PY101 | 10 | PG36 | 7 | 3100 | | | |
| | (green) | | | | | | | | |
| Example 5 | Fluorescent B5 | PY101 | 10 | PB15:3 | 5 | 1000 | 6.0 | 7000 | 4.7 |
| | (green) | | | | | | | | |
| | Fluorescent C1 | PY101 | 10 | PY74 | 3 | 6000 | | | |
| | (yellow) | | | | | | | | |
| Example 6 | Fluorescent A1 | BR1:1 | 3 | PR122 | 4 | 1000 | 6.0 | 7000 | 4.9 |
| | (pink) | | | | | | | | |
| | Fluorescent D1 | SO63 | 3 | PO64 | 2 | 6000 | | | |
| | (orange) | | | | | | | | |
| Example 7 | Fluorescent A4 | BR1:1 | 3 | PR122 | 1 | 4900 | 1.5 | 12300 | 3.7 |
| | (pink) | | | | | | | | |
| | Fluorescent B6 | PY101 | 10 | PG58 | 4 | 7400 | | | |
| | (green) | | | | | | | | |
| Example 8 | Fluorescent A5 | BR1:1 | 3 | PR122 | 5 | 520 | 9.8 | 5620 | 2.7 |
| | (pink) | | | | | | | | |
| | Fluorescent B7 | PY101 | 10 | PG36 | 5.5 | 5100 | | | |
| | (green) | | | | | | | | |
| Example 9 | Fluorescent A6 | BR1:1 | 3 | PR122 | 2.5 | 2350 | 1.3 | 5450 | 2.8 |
| | (pink) | | | | | | | | |
| | Fluorescent B8 | PY101 | 10 | PG36 | 7 | 3100 | | | |
| | (green) | | | | | | | | |
| Example 10 | Fluorescent A3 | BR1:1 | 3 | PR122 | 4 | 900 | 10.6 | 10400 | 5.2 |
| | (pink) | | | | | | | | |
| | Fluorescent B9 | PY101 | 12 | PG58 | 3 | 9500 | | | |
| | (green) | | | | | | | | |
| Example 11 | Fluorescent A7 | BR1:1 | 3 | PR122 | 5.5 | 480 | 10.6 | 5580 | 2.5 |
| | (pink) | | | | | | | | |
| | Fluorescent B7 | PY101 | 10 | PG36 | 5.5 | 5100 | | | |
| | (green) | | | | | | | | |
| Example 12 | Fluorescent A1 | BR1:1 | 3 | PR122 | 4 | 1000 | 11.0 | 12000 | 6.0 |
| | (pink) | | | | | | | | |
| | Fluorescent B10 | PY101 | 12 | PG58 | 2 | 11000 | | | |
| | (green) | | | | | | | | |
| Comparative | Fluorescent B1 | PY101 | 10 | PG36 | 5 | 6000 | 0.2 | 7000 | 1.8 |
| Example 1 | (green) | | | | | | | | |
| | Fluorescent A1 | BR1:1 | 3 | PR122 | 4 | 1000 | | | |
| | (pink) | | | | | | | | |
| Comparative | Fluorescent C1 | PY101 | 10 | PY74 | 3 | 6000 | 0.2 | 7000 | 2.1 |
| Example 2 | (yellow) | | | | | | | | |
| | Fluorescent B4 | PY101 | 10 | PB15:3 | 5 | 1000 | | | |
| | (green) | | | | | | | | |

Details of the abbreviations in Tables 1 and 2 are as below.
PG36: C.I. Pigment Green 36 (manufactured by TOYOCOLOR CO., LTD., LIONOL GREEN 8624), a non-fluorescent copper phthalocyanine colorant having a chlorine atom and a bromine atom.
PB15:3: C.I. Pigment Blue 15:3 (manufactured by TOYOCOLOR CO., LTD., LIONOL BLUE FG-7330), a non-fluorescent copper phthalocyanine colorant having no halogen atom.
PG58: C.I. Pigment Green 58 (manufactured by DIC Corporation, FASTOGEN GREEN A410), a zinc phthalocyanine non-fluorescent colorant having a chlorine atom and a bromine atom.
PY101: C.I. Pigment Yellow 101 (manufactured by Radiant Color, Radglo VSF-0-01, emission peak wavelength 520 nm), an azomethine-based fluorescent colorant.
PO64: C.I. Pigment Orange 64 (manufactured by Heubach GmbH, PV Fast Orange GRL), a perinone-based non-fluorescent colorant.
PY74: C.I. Pigment Yellow 74 (manufactured by Sun Chemical, Sunbrite Yellow 74/272-5147), a monoazo-based non-fluorescent colorant
PR122: C.I. Pigment Red 122 (manufactured by DIC Corporation, FASTOGEN SUPER MAGENTA RFS), a quinacridone-based non-fluorescent colorant
BR1: 1: C.I. Basic Red 1:1 (manufactured by TAKAOKA CHEMICAL INDUSTRIES, LTD., Rhodamine 6GCP-N), Rhodamine-based fluorescent colorant SO63: C.I. Solvent Orange 63 (manufactured by NEE LIKON, Neeliglow Orange 63), xanthene-based fluorescent colorant

(((1))) An image forming apparatus includes a first image forming unit that forms a first toner image by using a toner having a first fluorescent color, a second image forming unit that forms a second toner image by using a toner having a second fluorescent color, and a transfer unit that transfers the first toner image to a recording medium by superimposing the first toner image on the second toner image such that the first toner image is located above the second toner image on the recording medium, in which a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

(((2))) The image forming apparatus according to (((1))),
wherein a ratio (the toner having the second fluorescent color/the toner having the first fluorescent color) of the photoluminescent intensity in a case where the toner image formed by using only the toner having the second fluorescent color is irradiated with ultraviolet rays having a wavelength of 365 nm to the photoluminescent intensity in a case where the toner image formed by using only the toner having the first fluorescent color is irradiated with ultraviolet rays having a wavelength of 365 nm is 1.5 or more.

(((3))) The image forming apparatus according to (((2))),
wherein the ratio (the toner having the second fluorescent color/the toner having the first fluorescent color) of the photoluminescent intensity in a case where the toner image formed by using only the toner having the second fluorescent color is irradiated with ultraviolet rays having a wavelength of 365 nm to the photoluminescent intensity in a case where the toner image formed by using only the toner having the first fluorescent color is irradiated with ultraviolet rays having a wavelength of 365 nm is 1.5 or more and 10.0 or less.

(((4))) The image forming apparatus according to any one of (((1))) to (((3))),
wherein the photoluminescent intensity in a case where the toner image formed by using only the toner having the second fluorescent color is irradiated with ultraviolet rays having a wavelength of 365 nm is 3,000 or more and 10,000 or less.

(((5))) The image forming apparatus according to any one of (((1))) to (((4))),
wherein the photoluminescent intensity in a case where the toner image formed by using only the toner having the first fluorescent color is irradiated with ultraviolet rays having a wavelength of 365 nm is 500 or more and 5,000 or less.

(((6))) The image forming apparatus according to any one of (((1))) to (((5))),
wherein the toner having the second fluorescent color contains an azomethine compound.

(((7))) The image forming apparatus according to any one of (((1))) to (((6))),
wherein the toner having the second fluorescent color contains C.I. Pigment Yellow 101.

(((8))) An image forming method comprising:
forming a first toner image by using a toner having a first fluorescent color;
forming a second toner image by using a toner having a second fluorescent color; and
transferring the first toner image to a recording medium by superimposing the first toner image on the second toner image such that the first toner image is located above the second toner image on the recording medium,
wherein a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a first image forming unit that forms a first toner image by using a toner having a first fluorescent color;
a second image forming unit that forms a second toner image by using a toner having a second fluorescent color; and
a transfer unit that transfers the first toner image to a recording medium by superimposing the first toner image on the second toner image such that the first toner image is located above the second toner image on the recording medium,
wherein a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

2. The image forming apparatus according to claim 1,
wherein a ratio (the toner having the second fluorescent color/the toner having the first fluorescent color) of the photoluminescent intensity in a case where the toner image formed by using only the toner having the second fluorescent color is irradiated with ultraviolet rays having a wavelength of 365 nm to the photoluminescent intensity in a case where the toner image formed by using only the toner having the first fluorescent color is irradiated with ultraviolet rays having a wavelength of 365 nm is 1.5 or more.

3. The image forming apparatus according to claim 2,
wherein the ratio (the toner having the second fluorescent color/the toner having the first fluorescent color) of the photoluminescent intensity in a case where the toner image formed by using only the toner having the second fluorescent color is irradiated with ultraviolet rays having a wavelength of 365 nm to the photoluminescent intensity in a case where the toner image formed by using only the toner having the first fluorescent color is irradiated with ultraviolet rays having a wavelength of 365 nm is 1.5 or more and 10.0 or less.

4. The image forming apparatus according to claim 1,
wherein the photoluminescent intensity in a case where the toner image formed by using only the toner having the second fluorescent color is irradiated with ultraviolet rays having a wavelength of 365 nm is 3,000 or more and 10,000 or less.

5. The image forming apparatus according to claim 1,
wherein the photoluminescent intensity in a case where the toner image formed by using only the toner having the first fluorescent color is irradiated with ultraviolet rays having a wavelength of 365 nm is 500 or more and 5,000 or less.

6. The image forming apparatus according to claim 1,
wherein the toner having the second fluorescent color contains an azomethine compound.

7. The image forming apparatus according to claim 1,
wherein the toner having the second fluorescent color contains C.I. Pigment Yellow 101.

8. The image forming apparatus according to claim 6,
wherein the toner having the first fluorescent color contains a xanthene compound.

9. An image forming method comprising:
forming a first toner image by using a toner having a first fluorescent color;
forming a second toner image by using a toner having a second fluorescent color; and
transferring the first toner image to a recording medium by superimposing the first toner image on the second toner image such that the first toner image is located above the second toner image on the recording medium,
wherein a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.

10. The image forming method according to claim 9,
wherein a ratio (the toner having the second fluorescent color/the toner having the first fluorescent color) of the photoluminescent intensity in a case where the toner image formed by using only the toner having the second fluorescent color is irradiated with ultraviolet rays having a wavelength of 365 nm to the photoluminescent intensity in a case where the toner image formed by using only the toner having the first fluorescent color is irradiated with ultraviolet rays having a wavelength of 365 nm is 1.5 or more.

11. The image forming method according to claim 10,
wherein the ratio (the toner having the second fluorescent color/the toner having the first fluorescent color) of the photoluminescent intensity in a case where the toner image formed by using only the toner having the second fluorescent color is irradiated with ultraviolet rays having a wavelength of 365 nm to the photoluminescent intensity in a case where the toner image formed by using only the toner having the first fluorescent color is irradiated with ultraviolet rays having a wavelength of 365 nm is 1.5 or more and 10.0 or less.

12. The image forming method according to claim 9,
wherein the photoluminescent intensity in a case where the toner image formed by using only the toner having the second fluorescent color is irradiated with ultraviolet rays having a wavelength of 365 nm is 3,000 or more and 10,000 or less.

13. The image forming method according to claim 9,
wherein the photoluminescent intensity in a case where the toner image formed by using only the toner having the first fluorescent color is irradiated with ultraviolet rays having a wavelength of 365 nm is 500 or more and 5,000 or less.

14. The image forming method according to claim 9,
wherein the toner having the second fluorescent color contains an azomethine compound.

15. The image forming method according to claim 9,
wherein the toner having the second fluorescent color contains C.I. Pigment Yellow 101.

16. The image forming method according to claim 14,
wherein the toner having the first fluorescent color contains a xanthene compound.

17. An image forming apparatus comprising:
means for forming a first toner image by using a toner having a first fluorescent color;
means for forming a second toner image by using a toner having a second fluorescent color; and
means for transferring the first toner image to a recording medium by superimposing the first toner image on the second toner image such that the first toner image is located above the second toner image on the recording medium,
wherein a photoluminescent intensity in a case where the toner image formed by using only the toner having the second fluorescent color is irradiated with ultraviolet rays having a wavelength of 365 nm is higher than a photoluminescent intensity in a case where the toner image formed by using only the toner having the first fluorescent color is irradiated with ultraviolet rays having a wavelength of 365 nm.
